(19) United States
(12) Patent Application Publication
(10) Pub. No.: US 2026/0074425 A1
(43) Pub. Date: Mar. 12, 2026

(54) ANTENNA DEVICE

(71) Applicant: Niterra Co., Ltd., Nagoya-shi, Aichi (JP)

(72) Inventors: Akihiro MARUYAMA, Nagoya-shi (JP); Daisuke YAMASHITA, Nagoya-shi (JP); Muneyuki IWATA, Nagoya-shi (JP)

(21) Appl. No.: 19/134,105

(22) PCT Filed: May 30, 2024
(86) PCT No.: PCT/JP2024/019948

§ 371 Date: May 29, 2025

(30) Foreign Application Priority Data
Jun. 2, 2023 (JP) 2023-091865
Apr. 17, 2024 (JP) 2024-067067

(51) Int. Cl. H01Q 9/04; H01Q 21/24

(52) U.S. Cl. CPC H01Q 9/0414; H01Q 9/0485; H01Q 21/24

(57) ABSTRACT

Provided is an antenna device which can achieve wide-angle radiation directivity, by using a single patch antenna, without causing an increase in the size of the device and an increase in the degree of complexity of its configuration, which increases would otherwise occur as a result of arraying a plurality of antennas. An antenna device configured by using a dielectric substrate includes a patch antenna formed in a predetermined conductor layer, a cavity formed in a dielectric layer disposed above the predetermined conductor layer and having a shape which encompasses the patch antenna in a plan view as viewed in a Z direction, which is the thickness direction of the dielectric substrate, and ground conductors disposed to face the dielectric layer in the Z direction with the predetermined conductor layer intervening therebetween.

### TECHNICAL FIELD

The present invention relates to an antenna device configured by using a dielectric substrate.

### BACKGROUND ART

In mobile communications such as 5G and 6G mobile communications, antenna devices are required to have wide-angle radiation directivity, which enables transmission and reception of radio waves in various directions in order to transmit and receive radio waves of a high-frequency band in various environments such as inside and outside buildings. In a known method which meets such a requirement, an array antenna in which a plurality of antenna elements are arranged in an array is configured so as to obtain wide-angle radiation directivity as a whole. For example, Patent Document 1 discloses a technique related to an array antenna in which a plurality of antennas are arranged in an array, wherein beam forming is performed by providing a phase difference to each antenna, thereby obtaining wide-angle radiation directivity.

PRIOR ART DOCUMENT

### Patent Document

Patent Document 1: Japanese Patent No. 6818757

### SUMMARY OF THE INVENTION

### Problem to be Solved by the Invention

In recent years, a structure using a dielectric substrate has been widely used in antenna devices, from the viewpoint of miniaturization and weight reduction. For example, miniaturization of an antenna device is easily achieved by forming one patch antenna on a dielectric substrate. However, it is difficult to realize wide-angle radiation directivity. As described above, in order to realize the wide-angle radiation directivity of the antenna device, an array antenna must be configured by arranging a plurality of antennas (e.g., patch antennas) in an array on a dielectric substrate.

However, the array antenna using a dielectric substrate requires a space to dispose a plurality of antennas, and its size increases, which makes it difficult to reduce the size of the antenna device. In addition, it is necessary to form a complex electronic circuit which provides phase differences for beam forming to the plurality of antennas, which increases both component cost and assembly cost, and tightens dimensional tolerances at the time of manufacture of the dielectric substrate.

As described above, in the case where an antenna device using a dielectric substrate is configured by the conventional method described above, it has been difficult to realize wide-angle radiation directivity while realizing miniaturization and low cost.

The present invention has been accomplished to solve the above-described problem and realizes an antenna device which is configured by using a dielectric substrate and in which only one patch antenna is disposed on the dielectric substrate, thereby enabling miniaturization of the antenna device and cost reduction, while maintaining wide-angle radiation directivity.

### Means for Solving the Problem

An antenna device (1) of the present invention, which solves the above-described problem, is an antenna device which is configured by using a dielectric substrate and includes a patch antenna (20) formed in a predetermined conductor layer of the dielectric substrate; a cavity (12) formed in a dielectric layer (11) disposed above the predetermined conductor layer of the dielectric substrate, the cavity having a shape which encompasses the patch antenna in a plan view as viewed in a first direction (Z), which is a thickness direction of the dielectric substrate; and a ground conductor (21, 22, 23) disposed to face the dielectric layer in the first direction with the predetermined conductor layer intervening therebetween.

In the antenna device of the present invention which uses a dielectric substrate, a patch antenna of a predetermined conductor layer and a ground conductor right below the patch antenna are formed, a cavity is formed in a dielectric layer stacked above the patch antenna, and the cavity has a shape which encompasses the patch antenna in a plan view as viewed in the first direction. By virtue of such a configuration, the radiation direction of radio waves radiated from the patch antenna via a feeding structure expands due to the influence of an electromagnetic field distribution on a dielectric surface which forms the side wall of the cavity located above the patch antenna. Therefore, the radiation directivity is widened. Accordingly, space increase for disposing a plurality of antennas in an array is not required, and a complex electronic circuit for phase control at the time of beam forming becomes unnecessary, whereby miniaturization of the antenna device and cost reduction can be easily achieved.

In the present invention, each of the patch antenna and the cavity may have any of various shapes in the plan view as viewed in the first direction. For example, a patch antenna and a cavity each having a rectangular shape in the plan view as viewed in the first direction, or a patch antenna and a cavity each having a circular shape in the plan view as viewed in the first direction can be employed. In addition, it is desired that the height of the cavity in the first direction falls within a range of 0.7 lambda to 0.8 lambda, where lambda represents a wavelength at a used frequency in the dielectric substrate. In addition, it is desired that, in the plan view as viewed in the first direction, an outer edge of the cavity is located outward of an outer edge of the patch antenna, and the distance between the outer edges is set to fall within a range of 0.03 lambda to 0.07 lambda.

In the present invention, in the plan view as viewed in the first direction, the patch antenna and the cavity may be disposed symmetrically with respect to the center of the dielectric substrate. By virtue of this configuration, the antenna device can have symmetric radiation directivity; i.e., can radiate radio waves in all directions from the approximate center in the substrate plane.

In the present invention, the ground conductor may be composed of a plurality of conductor layers connected to each other via a plurality of via conductors extending in the first direction. By virtue of this configuration, it is possible to increase the area of the ground conductor, thereby strengthening the ground and thus improving antenna characteristics.

In the present invention, a feeding structure for feeding one or both of horizontally polarized and vertically polarized waves may be provided for the patch antenna. By virtue of this configuration, it is possible to transmit and receive at least either of horizontally polarized waves and vertically polarized waves by using a single patch antenna, and appropriately and selectively use the horizontally polarized waves and vertically polarized waves in accordance with the situation of use.

### Effect of the Invention

According to the present invention, a single patch antenna is disposed on a dielectric substrate, and a cavity is disposed above the patch antenna. Therefore, it becomes possible to realize an antenna device with excellent usability by widening its radiation directivity, while avoiding an increase in size and an increase in cost, which would otherwise occur when the antenna device is configured by disposing a plurality of antennas in an array.

### BRIEF DESCRIPTION OF THE DRAWINGS

FIG. 1 Perspective view of an antenna device 1 of an embodiment as viewed from obliquely above.

FIG. 2 Cross-sectional structural view of the antenna device 1 of FIG. 1 in an A-A cross section.

FIG. 3 Plan view of the antenna device 1 of the embodiment as viewed from above.

FIG. 4 View used for describing the conductor structure of a lower portion of the antenna device 1 of the embodiment, etc.

FIG. 5 Chart showing, for comparison, the radiation directivity in an X-Z plane of the antenna device 1 of the embodiment and that of an antenna device of a comparative example.

FIG. 6 Chart showing, for comparison, the radiation directivity in a Y-Z plane of the antenna device 1 of the embodiment and that of the antenna device of the comparative example.

FIG. 7 Graph showing, for comparison, the reflection characteristic of the antenna device 1 of the embodiment and that of the antenna device of the comparative example.

FIG. 8 Perspective view (as viewed from obliquely above) of an antenna device 1 according to one modification to which the present invention is applied.

FIG. 9 Plan view of the antenna device 1 of the modification as viewed from above.

FIG. 10 Chart showing, for comparison, the radiation directivity in the X-Z plane of the antenna device 1 of the modification and that of the antenna device of the comparative example.

FIG. 11 Chart showing, for comparison, the radiation directivity in the Y-Z plane of the antenna device 1 of the modification and that of the antenna device of the comparative example.

### MODES FOR CARRYING OUT THE INVENTION

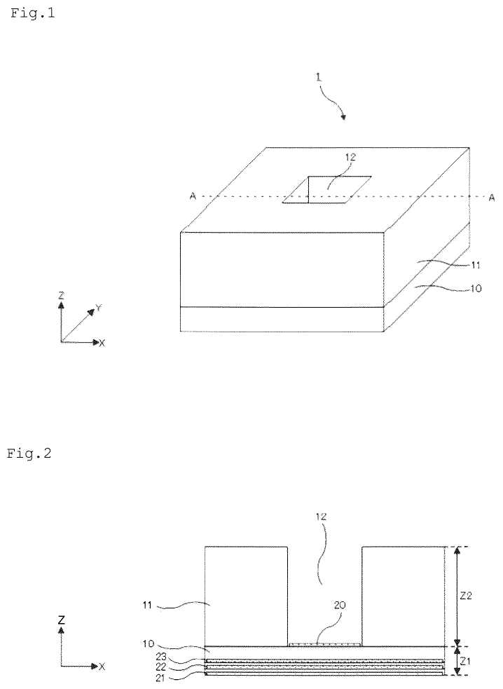

A preferred embodiment of the present invention will now be described with reference to FIGS. 1 to 11. In the present embodiment, an antenna device in which the present invention is embodied will be described. However, the embodiment described below is one example of the mode to which the present invention is applied, and the present invention is not limited by the contents of the present embodiment.

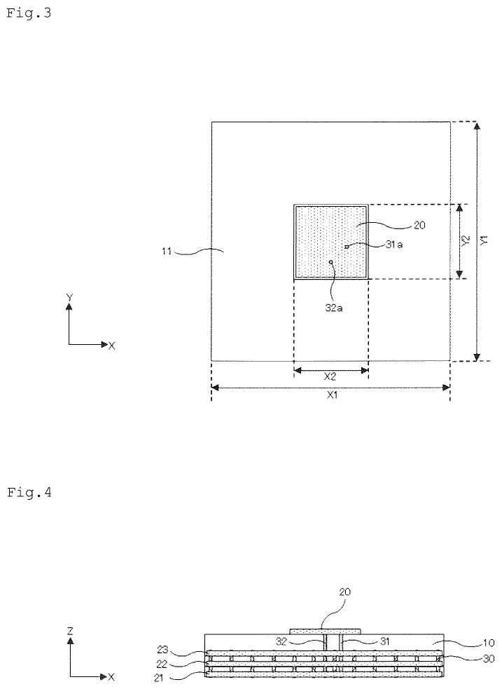

The structure of an antenna device 1, which is one example of the present embodiment, will be described with reference to FIGS. 1 to 4. FIG. 1 is a perspective view of the antenna device 1 as viewed from obliquely above. FIG. 2 is a cross-sectional structural view of the antenna device 1 of FIG. 1 in an A-A cross section. FIG. 3 is a plan view of the antenna device 1 as viewed from above. FIG. 4 is a view used for describing the conductor structure of a lower portion of the antenna device 1. Notably, in FIGS. 1 to 4, for the sake of explanation, an X direction, a Y direction, and a Z direction (first direction of the present invention), which are perpendicular to each other, are indicated by arrows.

The antenna device 1 of the present embodiment is configured by using a dielectric substrate made of a dielectric material, and the dielectric substrate has a structure in which a lower dielectric layer 10 and an upper dielectric layer 11 are stacked on top of each other. A patch antenna 20 is formed at the center of the surface of the lower dielectric layer 10, and a cavity 12 is formed at the center of the upper dielectric layer 11. Namely, in the dielectric layer 11, a rectangular hollow formed by removing the dielectric material at the center serves as the cavity 12. In addition, ground conductors 21, 22, and 23 which form a three-layer structure are disposed on a region of the lower side of the lower dielectric layer 10, the region facing the patch antenna 20.

As shown in FIGS. 2 and 3, in the plan view as viewed in the Z direction, the upper and lower dielectric layers 10 and 11 have rectangular planar shapes of the same size, the patch antenna 20 has a rectangular planar shape whose size is sufficiently smaller than that of the dielectric layer 11, and the cavity 12 has a rectangular planar shape whose size is slightly larger than that of the patch antenna 20. Namely, in the plan view, the cavity 12 is disposed to encompass the patch antenna 20. Therefore, the patch antenna 20 faces the air in the cavity 12 right above, and the patch antenna 20 is exposed to the outside.

FIG. 2 shows the height Z1 in the Z direction of the lower dielectric layer 10 and the height Z2 in the Z direction of the upper dielectric layer 11 (the height Z2 of the cavity 12). It can be seen that the Z2 is set larger than the Z1. FIG. 3 shows the length X1 in the X direction and the length Y1 in the Y direction of the upper and lower dielectric layers 10 and 11 and also shows the length X2 in the X direction and the length Y2 in the Y direction of the cavity 12. As already mentioned, X1 and Y1 are set larger than X2 and Y2. In addition, the size of the patch antenna 20 is set such that the length in the X direction is slightly smaller than X2, and the length in the Y direction is slightly smaller than Y2. FIGS. 1 to 4 show, as an example, the case where each of the dielectric layers 10 and 11 and the cavity 12 has a square planar shape, and the lengths X1, X2, Y1, and Y2 are set to satisfy the relations of X1=Y1 and X2=Y2.

In the present embodiment, specific dimensional conditions, such as X1, X2, Y1, Y2, Z1, and Z2 described above must be appropriately determined on the basis of the frequency band to be used, antenna characteristics, etc. For example, assuming use of a frequency of 28 GHz, the dimensional conditions are set as follows:
X1=Y1 =7.6 mm, Z1 =0.6 mm, and Z2 =3.3 mm for the dielectric layers 10 and 11, and
X2=Y2=2.35 mm for the cavity 12.

Notably, the height of the cavity 12 coincides with Z2, the dimensions of the patch antenna 20 in the X and Y directions are slightly smaller than X2 and Y2 and are about 2 mm. In general, the lower the frequency band used, the larger the values to which the dimensional parameters must be set, and, the higher the frequency band used, the smaller the values to which the dimensional parameters must be set.

Next, the conductor structure of the antenna device 1 will be described with reference to FIG. 4. In FIG. 4, only the region of the lower dielectric layer 10 is shown with the upper dielectric layer 11 removed, and, in addition to the patch antenna 20 and the ground conductors 21, 22, and 23, a plurality of via conductors 30, 31, and 32 extending in the dielectric layer 10 in the stacking direction are shown. The three ground conductors 21, 22, and 23 forming three layers are disposed in this order from the lower layer side. Each of the ground conductors 21, 22, and 23 is formed to expand over almost the entire rectangular region of the dielectric layer 10. The three ground conductors 21, 22, and 23 are electrically connected with each other via a plurality of via conductors 30. Since the ground conductors 21, 22, and 23 having a large area are disposed to face the patch antenna 20 located thereabove, the ground of the antenna device 1 is strengthened, which is effective for improving the antenna characteristics.

As shown in FIG. 4, two via conductors 31 and 32 functioning as feed lines are connected to the patch antenna 20. A high-frequency signal of a horizontally polarized wave is fed to one via conductor 31, and a high-frequency signal of a vertically polarized wave is fed to the other via conductor 32. In the patch antenna 20 of FIG. 3, an upper end portion 31a of the via conductor 31 for horizontally polarized waves and an upper end portion 32a of the via conductor 32 for vertically polarized waves are shown and are connected to the patch antenna 20 at respective positions which are deviated in the horizontal and vertical directions, respectively, from the center of the patch antenna 20. The lower ends of the via conductors 31 and 32 are connected to a pair of pads (not shown) on the bottom surface of the dielectric layer 10, thereby forming a structure which enables feeding of the high-frequency signals to the pair of feed lines from the outside. By virtue of such structure, the antenna device 1 can radiate either or both of horizontally polarized waves and vertically polarized waves through the feeding structure.

When a high-frequency signal is fed to the antenna device 1 of the present embodiment from the outside, basically, a radio wave is radiated upward in the Z direction. In a conventional general structure, the air fills the entire space above the patch antenna 20 on the surface of the dielectric layer 10 having the structure as shown in FIG. 4. In contrast, the structure of the present embodiment differs from the conventional structure in the point that the cavity 12 is present above the patch antenna 20. In the present embodiment, the role of the cavity 12 is to widen the radiation directivity of the antenna device 1. Conventionally, it has been difficult to realize wide-angle radiation directivity by merely providing one patch antenna 20. According to the antenna device 1 of the present embodiment, it becomes possible to obtain wide-angle radiation directivity mainly by virtue of the effect obtained as a result of providing the cavity 12. The results of verification of this point will be described later.

The results of verification of the antenna characteristics of the antenna device 1 of the present embodiment will be described with reference to FIGS. 5 to 7. Here, for comparison with the antenna device 1 of the present embodiment, the antenna characteristics of the antenna device 1 is compared with the antenna characteristics of an antenna device (comparative example) having a structure in which the upper dielectric layer 11 and the cavity 12 are not provided. This comparative example has a structure as shown in FIG. 4, and the patch antenna 20 is disposed on the uppermost portion of the dielectric layer 10. Notably, the dimensional parameters of the comparative example are approximately the same as those of the antenna device 1 of the present embodiment.

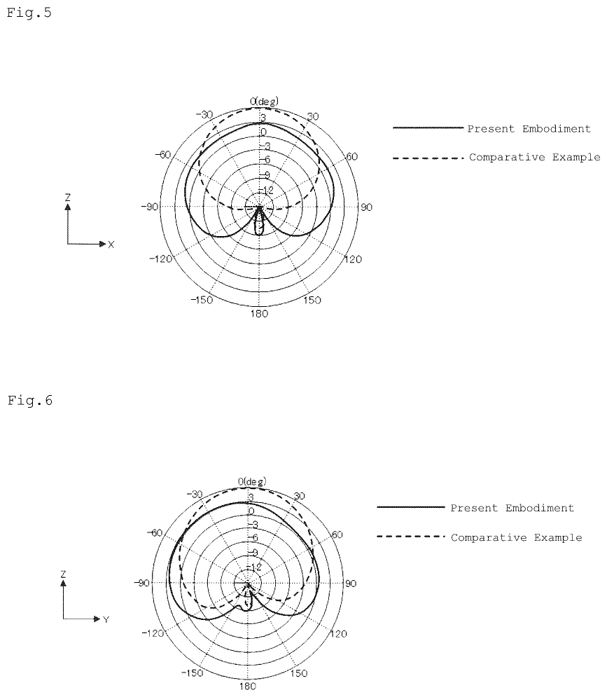

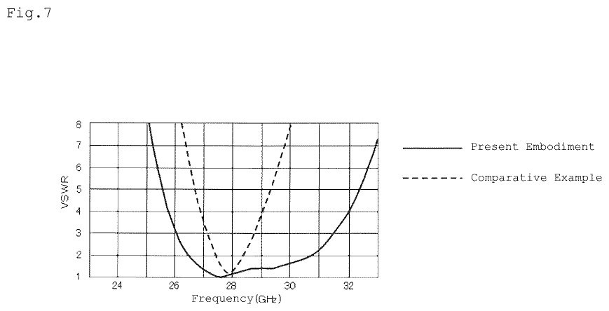

Each of FIGS. 5 and 6 is a chart showing, for comparison, the radiation directivity of the antenna device 1 of the present embodiment and the radiation directivity of the antenna device of the comparative example. FIG. 5 shows the directivity in the X-Z plane, and FIG. 6 shows the directivity in the Y-Z plane. Each chart shows the result of verification, through simulation, of the directivity of radio waves radiated from the patch antenna 20 as a result of input of a signal having a frequency of 28 GHz. In FIGS. 5 and 6, the radiation directivity (solid line) of the present embodiment and the radiation directivity (broken line) of the comparative example are shown in a superimposed manner.

As shown in FIGS. 5 and 6, the radiation directivity is such that the gain becomes the peak when the radiation direction is upward in the Z direction, and the gain decreases with deviation of the radiation direction from the Z direction in the X-Z plane or the Y-Z plane. In each of FIGS. 5 and 6, when the range between angles at which the gain becomes half of the peak is defined as a half-value width, in the case of the comparative example, the half-value width is about 90 degrees, while in the case of the present embodiment (solid line), the half-value width is greater than 180 degrees, which is more than twice that of the comparative example. Therefore, from the results shown in FIGS. 5 and 6, it was verified that the antenna device 1 of the present embodiment has wide-angle radiation directivity.

FIG. 7 is a chart showing, for comparison, the reflection characteristic of the antenna device 1 of the present embodiment and the reflection characteristic of the antenna device of the comparative example. The reflection characteristic is obtained by determining, through simulation, a VSWR (voltage standing wave ratio) representing the relation between an input signal and a reflection signal, which changes with frequency. In FIG. 7, the VSWR (solid line) of the present embodiment and the VSWR (broken line) of the comparative example are shown in a superimposed manner.

As shown in FIG. 7, the reflection characteristic is such that the VSWR becomes the smallest near the frequency of 28 GHz, and the VSWR increases with deviation from that frequency toward the lower frequency side or the higher frequency side. In the present embodiment, the frequency range in which the VSWR is good is relatively wide, whereas, in the case of the comparative example, the frequency range in which the VSWR is good is narrower than that in the case of the present embodiment. Specially, in the present embodiment, the frequency range in which the VSWR is 2 or smaller is four times or more of that of the comparative example. Therefore, from the results shown in FIG. 7, it was verified that the antenna device 1 of the present embodiment has a good reflection characteristic in a wide frequency range.

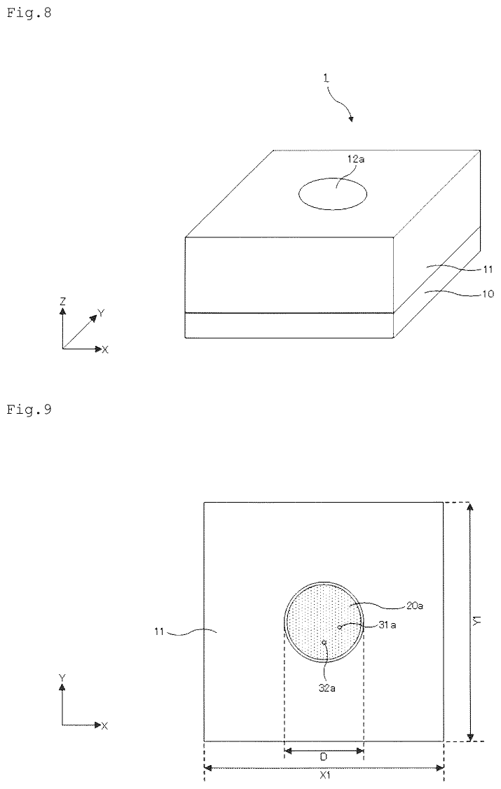

Next, an antenna device 1 according to one modification to which the present invention is applied will be described with reference to FIGS. 8 and 9. While the antenna device 1 in which each of the patch antenna 20 and the cavity 12 has a rectangular planar shape in the plan view as viewed in the Z direction has been described in the above-described embodiment, the antenna device 1 of the present modification has a patch antenna 20a and a cavity 12a whose shapes differ from those in the above-described embodiment. FIG. 8 is a perspective view (as viewed from obliquely above) of the antenna device 1 according to the present modification. FIG. 9 is a plan view of the antenna device 1 of FIG. 8 as viewed from above. FIGS. 8 and 9 correspond to FIGS. 1 and 3, respectively. Notably, since the structures shown in FIGS. 2 and 4 are approximately the same as those of the present modification, their description will not be repeated.

As shown in FIGS. 8 and 9, in terms of the structure shown in FIGS. 1 and 3, the antenna device 1 of the present modification differs from the antenna device 1 of the above-described embodiment in the point that each of the patch antenna 20a and the cavity 12a has a circular planar shape in the plan view as viewed in the Z direction. Namely, the cavity 12a is a circular hollow formed by removing the dielectric material from a center portion of the upper dielectric layer 11, and the patch antenna 20a is formed to have a circular shape at the center of the surface of the lower dielectric layer 10. Notably, in FIGS. 8 and 9, each of the upper and lower dielectric layers 10 and 11 has a rectangular planar shape as in the structure shown in FIGS. 1 and 3. In addition, like the structure shown in FIG. 2, three ground conductors 21, 22, and 23 forming a three-layer structure are disposed at the position of the lower dielectric layer 10. Similarly, in terms of the feeding structure shown in FIG. 4 and the layout of the upper end portion 31a and the upper end portion 32a (FIG. 9) of the via conductor 31 for horizontally polarized waves and the via conductor 32 for vertically polarized waves, the present modification is the same as the above-described embodiment.

As shown in FIG. 9, in the plan view as viewed in the Z direction, the circular cavity 12a has a diameter D, and the diameter of the circular patch antenna 20a is slightly smaller than the diameter D. Namely, the arrangement of the cavity 12a to encompass the patch antenna 20a in the plan view is the same as that in FIG. 3. Notably, of the dimensional conditions of the present modification, the heights Z1 and Z2 (FIG. 2) of the dielectric layers 10 and 11 in the Z direction and the length X1 in the X direction and the length Y1 in the Y direction of the upper and lower dielectric layers 10 and 11 are the same as those in the above-described embodiment. As for the diameter D shown in FIG. 9, like other dimensional conditions, it is necessary to appropriately determine in accordance with the frequency band to be used, antenna characteristics, etc.

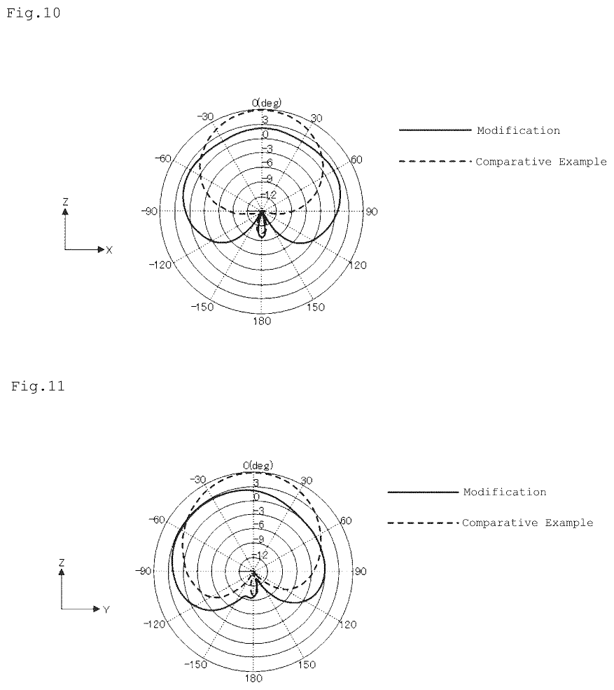

FIGS. 10 and 11 are charts which relate to the antenna device 1 of the present modification and show radiation directionalities similar to those of FIGS. 5 and 6. Each chart shows the result of verification, through simulation, of the directivity of radio waves radiated from the patch antenna 20a as a result of input of a signal having a frequency of 28 GHz. In FIGS. 10 and 11, the radiation directionalities (broken lines) of the comparative example, which are the same as those shown in FIGS. 5 and 6 are shown in such a manner that they are superimposed on the radiation directionalities (solid lines) of the present modification. The radiation directionalities shown FIGS. 10 and 11 are approximately the same as the radiation directionalities shown in FIGS. 5 and 6, and it was verified that, even when the structure of the present modification is employed, the antenna device 1 has the effect of obtaining wide-angle radiation directivity. Notably, although not shown in the drawings, the reflection characteristic of the present modification is approximately the same as that shown in FIG. 7.

As having been described above, by adopting the structure of the antenna device 1 to which the present invention is applied, it is possible to realize good antenna characteristics including wide-angle radiation directivity. Namely, the structure in which the patch antenna 20 is disposed on the surface of the dielectric layer 10 as in the past results in radiation directivity of a relatively narrow angle. In contrast, in the embodiments including the above modification (hereinafter referred to as the present embodiments), widening of radiation directivity becomes possible by virtue of the effect obtained by providing the cavity 12 in the dielectric layer 11 stacked above the dielectric layer 10. It is assumed that the radio wave radiated upward in the Z direction from the patch antenna 20 generates electromagnetic field distributions on the dielectric surfaces which form the four side walls of the cavity 12, and the electromagnetic field distributions propagate in the Z direction to an upper opening of the cavity 12 and then expand in various directions, whereby the radiation directivity becomes wide (wide-angle radiation directivity).

In the case of the conventional structure, in order to realize wide-angle radiation directivity, it is necessary to employ a method of configuring an array antenna by disposing a plurality of antennas in an array and controlling the phases of the antennas by beam forming. In contrast, in the case of the antenna device 1 of the present embodiment, since wide-angle radiation directivity is obtained by only one patch antenna 20 without configuring an array antenna, a space for disposing the plurality of antennas becomes unnecessary, and a complex electronic circuit for providing a phase difference to each antenna also becomes unnecessary. Accordingly, in addition to having the aforementioned advantage in terms of antenna performance, the antenna device 1 of the present embodiment is suitable for reducing the size of the antenna device 1 by reducing the size of the dielectric substrate, compared to the case where a plurality of antennas are arrayed by the conventional configuration. Thus, the dimensional tolerance at the time of manufacture of the dielectric substrate can also be relaxed, and it is possible reduce costs by reducing the cost of components and the cost of mounting.

Notably, in the present embodiment, in order to realize good antenna characteristics, including wide-angle radiation directivity, it is important to appropriately set the dimensional parameters as described above. Namely, although the dimensional parameters of the antenna device 1 are not limited to those of the structure shown in FIGS. 1 to 4, it is desirable to use the setting which matches a wavelength (lambda) corresponding to the used frequency in the dielectric substrate. This wavelength (lambda) is a wavelength determined in consideration of the wavelength shortening effect in the dielectric substrate. Specifically, for the wavelength (lambda) at the used frequency in the dielectric substrate, the height Z2 of the upper dielectric layer 11 (the height of the cavity 12) in the Z direction is desirably set to fall within the range of 0.7 lambda to 0.8 lambda. In addition, the length X2 of the cavity 12 in the X direction and the length Y2 of the cavity 12 in the Y direction are desirably set to be greater than the dimensions (in the X direction and the Y direction) of the rectangle of the patch antenna 20 by a length within the range of 0.03 lambda to 0.07 lambda. The conditions of such dimensional parameters are desirable setting to secure desired antenna characteristics of the antenna device 1, such as wide-angle radiation directivity and good reflection characteristic.

In the present embodiment, the case where, as shown in FIG. 3, the patch antenna 20 and the cavity 12 have rectangular and circular planar shapes in the plan view as viewed in the Z direction has been described. However, their planar shapes are not limited to rectangular and circular shapes, and they may have different planar shapes. For example, even when each of the patch antenna 20 and the cavity 12 has a polygonal planar shape other than the rectangular shape, the present invention can be applied. Even in such a case, it is possible to obtain the action and effect of the antenna device 1 to which the present invention is applied. Furthermore, in the present embodiment, there has been described the case where, in the plan view as viewed in the Z direction, the patch antenna 20 and the cavity 12 are symmetrically disposed with respect to the centers of the dielectric layers 10 and 11. However, the present invention can be applied to the case where the patch antenna 20 and the cavity 12 are asymmetrically disposed with respect to the centers.

Although the details of the present invention have been described above on the basis of the present embodiment, the present invention is not limited to the embodiment, and various modifications can be made without departing from the gist of the invention. Namely, the basic structure of the antenna device 1 having been described with reference to FIGS. 1 to 4 is merely an example, and the present invention, can be widely applied to various antenna device 1 to which other structures and shapes are applied, so long as the action and effect of the present invention are achieved. For example, the shape, feeding method, size, etc. of the patch antenna 20 can be changed in various ways, so long as the action and effect of the present invention are achieved.

### DESCRIPTION OF REFERENCE NUMERALS

1: antenna device
10, 11: dielectric layer
12, 12a: cavity
20, 20a: patch antenna
21, 22, 23: ground conductor
30, 31, 32: via conductor

What is claimed is:

1. An antenna device configured by using a dielectric substrate, comprising:
a patch antenna formed in a predetermined conductor layer of the dielectric substrate;
a cavity formed in a dielectric layer disposed above the predetermined conductor layer of the dielectric substrate, the cavity having a shape which encompasses the patch antenna in a plan view as viewed in a first direction, which is a thickness direction of the dielectric substrate; and
a ground conductor disposed to face the dielectric layer in the first direction with the predetermined conductor layer intervening therebetween.

2. The antenna device according to claim 1, wherein each of the patch antenna and the cavity has a rectangular shape in the plan view as viewed in the first direction.

3. The antenna device according to claim 1, wherein each of the patch antenna and the cavity has a circular shape in the plan view as viewed in the first direction.

4. The antenna device according to claim 1, wherein a height of the cavity in the first direction falls within a range of 0.7 lambda to 0.8 lambda, where lambda represents a wavelength at a used frequency in the dielectric substrate.

5. The antenna device according to claim 1, wherein, in the plan view as viewed in the first direction, an outer edge of the cavity is located outward of an outer edge of the patch antenna, and a distance between the outer edges is set to fall within a range of 0.03 lambda to 0.07 lambda.

6. The antenna device according to claim 1, wherein, in the plan view as viewed in the first direction, the patch antenna and the cavity are disposed symmetrically with respect to a center of the dielectric substrate.

7. The antenna device according to claim 1, wherein the ground conductor is composed of a plurality of conductor layers connected to each other via a plurality of via conductors extending in the first direction.

8. The antenna device according to claim 1, wherein a feeding structure for feeding one or both of horizontally polarized and vertically polarized waves is provided for the patch antenna.
